(19) United States
(12) Patent Application Publication
(10) Pub. No.: US 2002/0074085 A1
(43) Pub. Date: Jun. 20, 2002

(54) Stitchless seam construction of elastomeric material

(75) Inventor: Richard Huber, Coeur d'Alene, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hot House Holdings, Ltd., High Street Centre (SG)

(21) Appl. No.: 10/079,779

(22) Filed: Feb. 19, 2002

Related U.S. Application Data
(63) Continuation of application No. 09/166,247, filed on Oct. 5, 1998.
Application No. 09/166,247 is a continuation-in-part of application No. 08/924,056, filed on Aug. 28, 1997, now abandoned.

(51) Int. Cl. B29C 65/00

(52) U.S. Cl. 156/304.5

(57) ABSTRACT

A method is provided for joining two pieces of elastomeric fabric together without the need for sewing or stitching the seam. This is accomplished by cutting a first piece of elastomeric fabric to form a first edge having a predetermined first geometric pattern. Similarly, a second piece of elastomeric fabric is cut to form a second edge having a predetermined second geometric pattern which corresponds with the first geometric pattern. The lateral surfaces of the geometrically patterned first and second edges then have a bonding agent applied prior to mating the patterned edges to one another to create an intersecting seam between the first and second pieces of the elastomeric fabric. The intersecting seam is immobilized to allow the bonding agent to set. Tape may be placed on one or both sides of the seam for additional strengthening.

### CROSS-REFERENCES TO RELATED APPLICATIONS

This application is continuation of U.S. patent application Ser. No. 09/166,427, filed Oct. 5, 1998, which is a continuation-in-part of U.S. patent application Ser. No. 08/924,056, filed Aug. 28, 1997, abandoned. These applications are incorporated by reference in their entirety.

### BACKGROUND OF THE INVENTION

This invention relates to a stitchless method of seam construction of elastomeric fabric, such as medical devices useful for knee, arm, and torso braces and recreational suits and other articles of apparel such as diving suits, wetsuits, drysuits, gloves, headgear, waders, and elastomeric aviator and survival suits or parts fabric, which results in decreased costs of construction, better durability, impermeability, increased flexibility, and an overall increase in the strength of the articles of apparel of which the seam is a part.

Typically, two pieces of elastomeric fabric are joined together by gluing and butting the straight edges of two pieces of said fabric together. This is followed by stitching the two pieces together and then covering the inside seam with a tape, such as nylon. For example, in constructing a seam on a recreational suit, such as a wetsuit, the two pieces of fabric, commonly neoprene, are each glued on their edge and then butted together followed by blind-stitching the two pieces together where the stitching does not penetrate through to the other side of the neoprene. Other types of stitching are also used such as flat-stitching or overlock stitching. A heat welded or hand glued tape can then be placed over the seam on the inside to further strengthen the seam. However, the use of the stitching and tape reduces the stretch and flexibility of the neoprene. Most glued and stitched wearing articles of apparel are made in third world countries because the manufacturing process is labor intensive and the cost of labor in the third world countries is significantly less than in the United States.

Illustrative of the current methods of seam construction in elastomeric fabric, represented by recreational suits are U.S. Pat. Nos. 4,741,050; 4,593,418; 4,416,027; and 3,246,621 and French Patent Nos. 1,306,301 and 1,306,990. Related technology is found in U.S. Pat. No. 5,036,551 and British Patent No. GB 319,416.

U.S. Pat. No. 4,741,050 teaches that a seam can be constructed by inserting adhesive between two pieces of elastomeric fabric and then overlock stitching them together.

U.S. Pat. No. 4,593,418 teaches a variation of adhesive and stitching techniques with an elastomeric strip overlapping the adjoining pieces.

U.S. Pat. No. 4,416,027 teaches a method of seam construction in which two pieces of elastomeric fabric are slit along the lateral facing edges. A rubber filler fabric is then inserted with adhesive into the slits and the seam is thereby formed, followed by stitching on the outside of the suit, only.

U.S. Pat. No. 3,246,621 teaches a method which forms a seam by simply lock stitching abutting edges of fabric together.

The French Patent Nos. 1,306,301 and 1,306,990 refer to a technique which butts the edges together with adhesive and then adhesively applies an elastomeric strip to overlap the edges, followed by stitching.

U.S. Pat. No. 5,036,551 teaches a method of making laminated thermoplastic elastomeric fabrics. Incidental reference is made to forming a laminated seam without sewing by sealing with an adhesive. However, the seam described is formed by overlapping layers of thermoplastic elastomeric fabric (i.e. lamination), a technique which is effective and long-standing but does not attempt to adhere abutting edges of fabric which have already been laminated.

In this regard, it is important to note that most elastomeric fabrics are thermoplastics that can be “welded” to one another only if the fabrics have not already been cured by heat previously. For example, if a resin batch of neoprene has been formed into two sheets and cured by heat, those two sheets cannot be physically bound to one another by heat again. They will require the addition of an adhesive or other thermoplastic which has not yet undergone transformation (e.g. cured) by heat to be joined. Otherwise, if heat is again applied, these two pieces will simply degrade into a carbonized plastic retaining none of the desired properties.

British Patent No. GB 319,416 teaches butt joining elastomeric materials, and specifically deals with affixing a material to a backing or a surface. The purpose of the interlocking as described in this patent is to prevent fissures and cracking in cork when rubber is applied over it and subsequently stretched during ordinary wear.

The problems with the seam joining techniques described in the prior art are multiple. The seams are easily broken or separated because of stitch failures during normal wear. Stitches that pierce through the fabric weaken the seam and cause leakage. Stitching itself weakens the fabric by breaking up the macro of which the fabric is made. If the seam is taped after stitching, the taped strip causes skin irritation and can be dislodged from the seam itself through skin friction. This again opens up the sewn seam for failure. The use of stitching to join two pieces of fabric together in and of itself reduces the stretch and elasticity of the item of apparel of which the seam is a part, making the item of apparel less flexible and supple. Combining the stitching with the use of taping, or any other fabric to cover the sewn seam compounds this reduction in stretching, flexibility and elasticity. The failure of the seam, which is inherent in its method of construction, substantially increases the manufacturers' repair costs and lessens the life of the item of apparel. Lastly, stitching and taping is a labor intensive process, which is not only time consuming but expensive.

The present invention addresses these problems and provides other related advantages.

### SUMMARY OF THE INVENTION

The present invention resides in a method of joining two pieces of elastomeric fabric together without the need for sewing or stitching the seam. This is accomplished by utilizing a method of seam construction that relies on creating a first predetermined pattern which corresponds with a second predetermined pattern to form a stitchless seam.

In one embodiment, a first piece of an elastomeric fabric has an edge that is cut to form a predetermined first geometric pattern. The fabric may consist of conjugated dienes, polychloropene, chloropene, alpha olefin polymers and co-polymers, or neoprene. A second piece of an elastomeric fabric also has an edge that is cut to form a predetermined second geometric pattern. The first and second geometrically patterned edges matingly correspond to each other. Preferably, the geometric patterns have proximate and distal ends which are arcuate. A bonding agent is applied along the corresponding first and second geometrically patterned edges, which are then fit together to form a seam. The seam may be intersecting or interlocking depending on the form of the predetermined geometric pattern selected. The bonding agent may be double-sided tape, liquid thermoplastic polymer or an adhesive. These may be heat activated depending on the material used. The adhesive may consist of epoxies, urethanes, polyurethanes, cyanoacrylates, acrylics, or silicones. The fabric pieces are immobilized until the bonding agent has had opportunity to fully set, creating one piece of stitchless seamed fabric.

Another embodiment uses the above method, but tape is applied along the length of the seam on one or both sides of the fabric to further seal the seam. The tape may include a flexible polyester fabric having an adhesive coating on one side, and may be either heat welded or hand glued. In any event, the tape is set by heat activation.

Other features of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a top and side perspective view of a first piece of elastomeric fabric having straight edges;

FIG. 2A is a top and side perspective view of the piece of elastomeric fabric of FIG. 1 having an edge cut into a first geometric pattern;

FIG. 2B is a top and side perspective view of the piece of elastomeric fabric of FIG. 1 having an edge cut into another first geometric pattern;

FIG. 3 is a second piece of elastomeric fabric with straight edges;

FIG. 4A is a top and side perspective view of the second piece of elastomeric fabric of FIG. 3 having an edge cut into a second geometric pattern corresponding with the first geometric pattern of FIG. 2A;

FIG. 4B is a top and side perspective view of a piece of the elastomeric fabric of FIG. 3 having an edge cut into another second geometric pattern corresponding with the first geometric pattern of FIG. 2B;

FIG. 5A is a top plan view of the first piece of elastomeric fabric of FIG. 2A, being joined with the second piece of elastomeric fabric of FIG. 4A at their corresponding first and second geometrically patterned edges, creating a joined single piece of fabric with an interlocking seam;

FIG. 5B is a top plan view of the first piece of elastomeric fabric of FIG. 2B, being joined with the second piece of elastomeric fabric of FIG. 4B at their corresponding first and second geometrically patterned edges, creating a joined single piece of fabric with an interlocking seam;

FIG. 6A is a top plan view of the joined fabric with an interlocking seam of FIG. 5A with tape being applied over the length of the seam; and

FIG. 6B is a top plan view of the joined fabric with an interlocking seam of FIG. 5B with tape applied over the length of the seam.

### DETAILED DESCRIPTION

As shown in the drawings for purposes of illustration, the present invention resides in a method of joining two pieces of elastomeric fabric 10 and 12 together without the need for sewing or stitching a seam 14 therebetween.

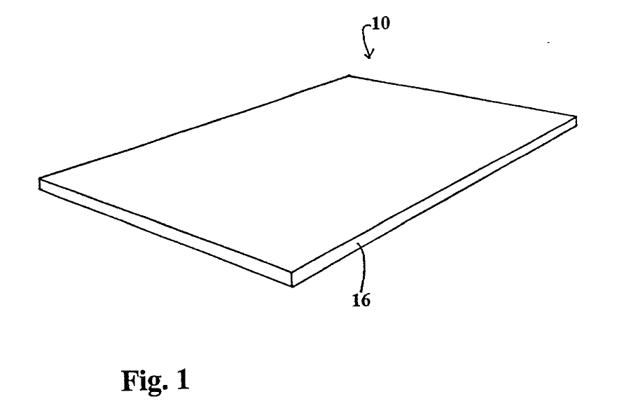

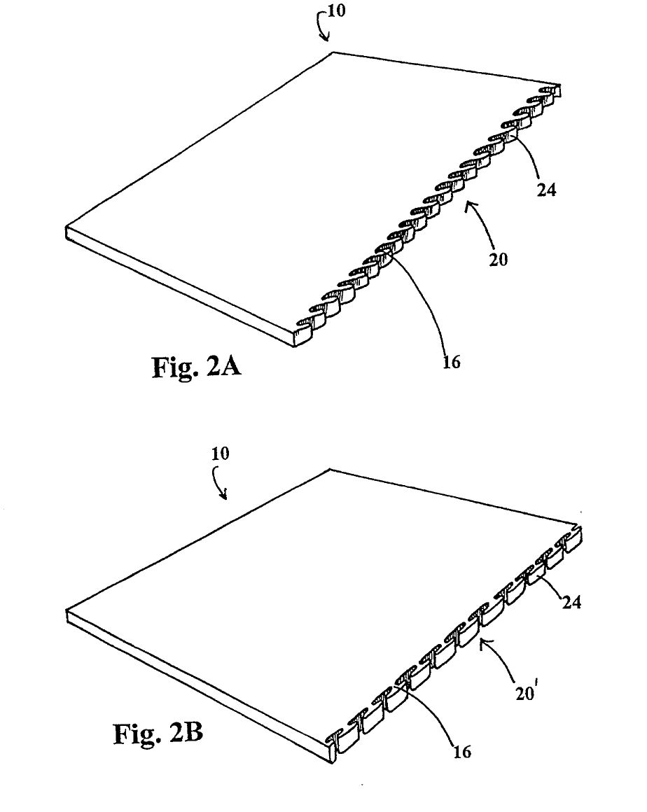

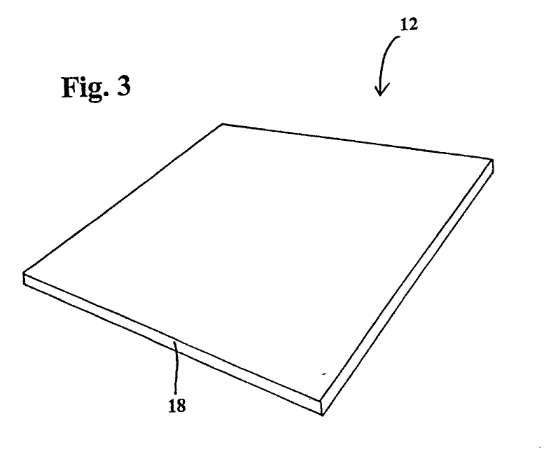

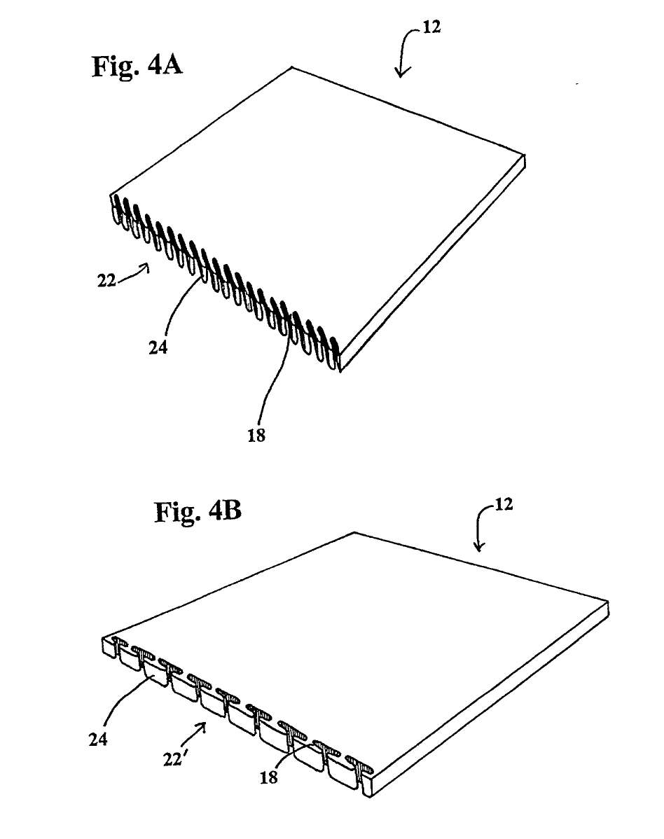

Referring to FIGS. 1 and 3, the first and second pieces of fabric 10 and 12 are preferably selected from the group consisting of conjugated dienes, polychloropene, chloropene, neoprene and alpha olefin polymers and co-polymers. The edges 16 and 18 that are to be brought together to join the fabric pieces 10 and 12 together and which will define the seam 14 are cut to form corresponding geometric patterns as illustrated in FIGS. 2A, 2B and 4A, 4B. With reference to FIGS. 2A and 2B, the edge 16 of the first piece of elastomeric fabric 10 is cut to form a predetermined first geometric pattern 20, 20′. The accompanying drawings illustrate two exemplary geometric patterns, but it should be understood that there are various additional possibilities of sizes and patterns that would be suitable for use in connection with the process of the present invention. Preferably, the first geometric pattern 20, 20′ includes arcuate surfaces which more effectively disperse the inevitable stresses and strains which will be placed on the seam 14, 14′. Similarly, the edge 18 of the second piece of elastomeric fabric 12 is cut to form a predetermined second geometric pattern 22, 22′ which corresponds with the first geometric pattern 20, 20′. See FIGS. 4A and 4B.

With the first and second geometric patterns 20, 20′ and 22, 22′ cut into the corresponding edges 16 and 18 of the first and second pieces of elastomeric fabric 10 and 12, a bonding agent is then applied to the exposed lateral surfaces of 24 of the edges 16 and 18. The bonding agent may be either double-sided tape, a liquid thermoplastic polymer, or an adhesive. The tape and polymer are heat activated in order to set. A preferred adhesive is a urethane as it generally tends to be more flexible than other adhesives, however, any adhesive of the epoxy, urethane, cyanoacrylate, acrylic, or silicone families will achieve the desired results.

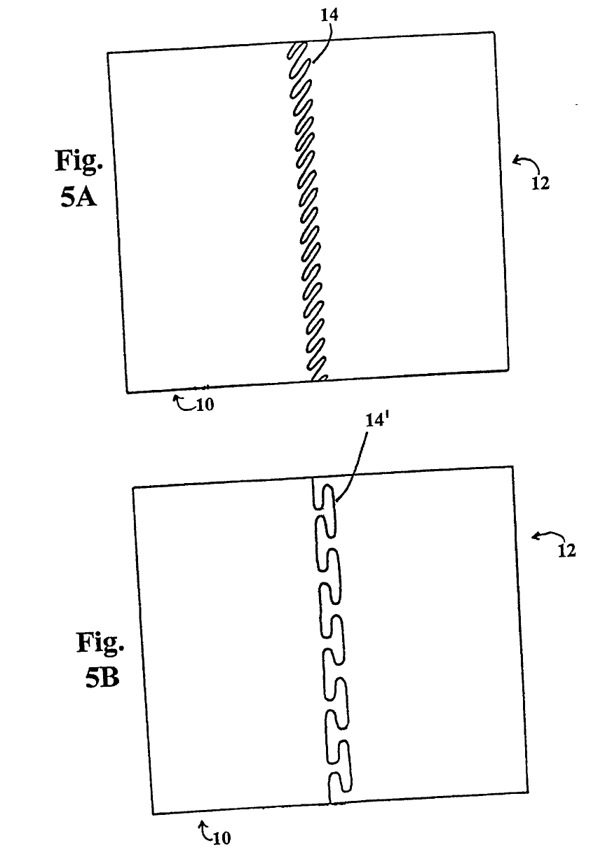

The first geometric patterned edge 16 is then mated with the second geometric patterned edge 18 to create an interlocking seam 14, 14′ between the first and second pieces of elastomeric fabric 10 and 12. See FIGS. 5A and 5B. The result is a single elastomeric fabric piece with an interlocking stitchless seam 14, 14′. The interlocking seam 14, 14′ is then immobilized until the bonding agent has had an opportunity to fully set

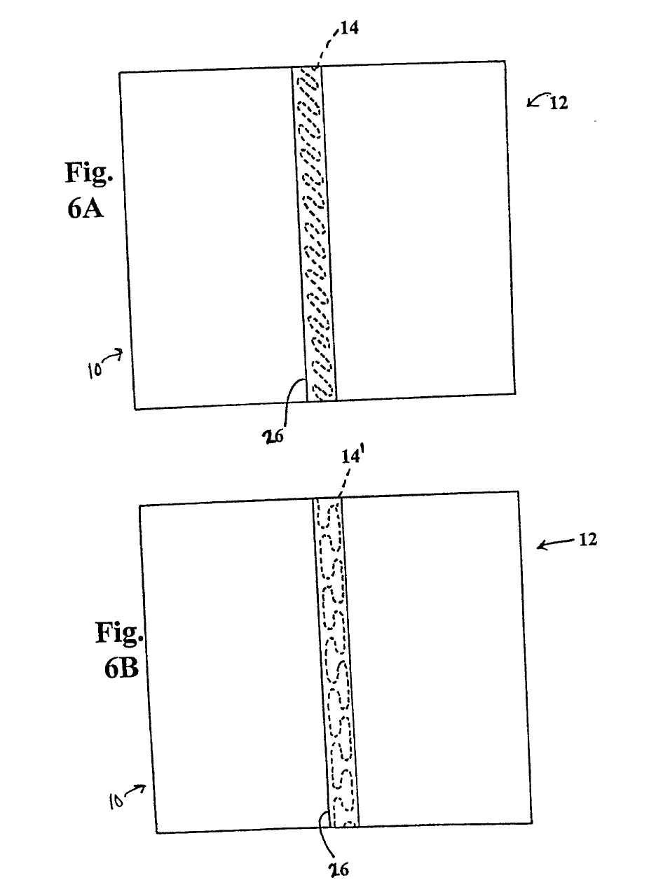

With reference to FIGS. 6A and 6B, a heat activated tape 26 may then be applied over one or both sides of the interlocking seam 14, 14′ to further seal the seam. Preferably, the tape 26 is applied by either heat welding or by hand gluing.

From the description above, a number of advantages in using this method of seam construction in elastomeric fabrics become evident. This method of seam construction eliminates the need for sewing or stitching. This provides for more comfortable, less skin irritating wearing apparel. This method also reduces the incidence of seam failure, often caused by the continual friction applied to the stitches of the seam. Without the need for stitching, the fabric is also more waterproof, eliminating the leakage often associated with sewn fabrics. A further advantage of this method as opposed to the stitching method is the decrease in the number of steps required to construct a seam, resulting in savings of time, labor and fabric. This will reduce the cost of manufacturing the item of apparel.

This method maintains the integrity of the fabric by the very nature of the intersecting geometric patterns which derive strength from the medial portions of the intersecting pattern through to the edge of the seam. This results in a stronger seam and also increases the stretch and elasticity of the fabric, creating a stronger, more flexible and supple item of apparel as compared to other methods.

Although the description set forth above illustrates alternative seam designs for purposes of illustration, these should not be construed as limiting the scope of the invention as various modifications may be made without departing from the spirit and scope of the invention. Accordingly, the invention is not to be limited, except as by the appended claims.

What is claimed is:

1. A method for providing a stitchless seam between two pieces of elastomeric fabric, comprising the steps of: cutting a first piece of elastomeric fabric to form a first edge having a predetermined first pattern; cutting a second piece of elastomeric fabric to form a second edge having a predetermined second pattern which corresponds with the first pattern; applying a bonding agent to the first and second patterned edges; mating the first patterned edge with the second patterned edge to create a seam between the first and second pieces of elastomeric fabric; and immobilizing the seam until the bonding agent has had opportunity to set.

2. The method of claim 1, wherein the first and second patterns are geometric.

3. The method of claim 2, wherein the first and second geometrically patterned edges intersect when mated.

4. The method of claim 3, wherein the first and second geometrically patterned edges interlock when mated.

5. The method of claim 1, wherein the elastomeric fabric is selected from the group consisting of conjugated dienes, polychloropene, chloropene, neoprene and alpha olefin polymers and co-polymers.

6. The method of claim 1, wherein the bonding agent comprises a heat activated double-sided tape.

7. The method of claim 1, wherein the bonding agent comprises a liquid thermoplastic polymer.

8. The method of claim 1, wherein the bonding agent comprises an adhesive.

9. The method of claim 8, wherein the adhesive is selected from the group consisting of epoxies, urethanes, polyurethanes, cyanoacrylates, acrylics, and silicones.

10. The method of claim 1, wherein the patterned edges have proximate and distal ends, and wherein the distal ends are arcuately shaped.

11. A method for providing a stitchless intersecting seam between two pieces of elastomeric fabric, comprising the steps of: cutting a first piece of elastomeric fabric to form a first edge having a predetermined first geometric pattern; cutting a second piece of elastomeric fabric to form a second edge having a predetermined second geometric pattern which corresponds with the first geometric pattern; applying a bonding agent to the first and second geometric patterned edges; mating the first geometric patterned edge with the second geometric patterned edge to create an intersecting seam between the first and second pieces of elastomeric fabric; immobilizing the intersecting seam until the bonding agent has had opportunity to set; and applying tape over a first side of the interlocking seam.

12. The method of claim 11, wherein the first and second geometrically patterned edges interlock when mated.

13. The method of claim 12, wherein the tape is heat activated to seal to the underlying first and second geometric patterned edges.

14. The method of claim 12, wherein tape is applied over a second side of the intersecting seam.

15. The method of claim 12, wherein the elastomeric fabric is selected from the group consisting of conjugated dienes, polychloropene, chloropene, neoprene, and alpha olefin polymers and co-polymers.

16. The method of claim 12, wherein the bonding agent comprises a heat activated double-sided tape.

17. The method of claim 12, wherein the bonding agent comprises a liquid thermoplastic polymer.

18. The method of claim 12, wherein the bonding agent comprises an adhesive selected from the group consisting of epoxies, urethanes, polyurethanes, cyanoacrylates, acrylics, and silicones.

19. The method of claim 12, wherein the patterned edges have proximate and distal ends, and wherein the distal ends of the patterned edge are rounded.

20. A method for providing a stitchless interlocking seam between two pieces of elastomeric fabric, comprising the steps of: cutting a first piece of elastomeric fabric to form a first edge having a predetermined first geometric pattern which includes arcuate surfaces; cutting a second piece of elastomeric fabric to form a second edge having a predetermined second geometric pattern which corresponds with the first geometric pattern; applying a bonding agent to the first and second geometric patterned edges; mating the first geometric patterned edge with the second geometric patterned to edge create an interlocking seam between the first and second pieces of elastomeric fabric; immobilizing the interlocking seam until the bonding agent has had opportunity to fully set; and applying heat activated tape over a first side of the interlocking seam.

21. The method of claim 20, wherein the tape comprises a flexible polyester fabric having an adhesive coating on one side thereof.

22. The method of claim 21, wherein the tape is applied by either heat welding or by hand gluing.

23. The method of claim 20, wherein the bonding agent is selected from the group consisting of heat activated double-sided tape, liquid thermoplastic polymer, or an adhesive.

24. The method of claim 23, wherein the adhesive is selected from the group consisting of epoxies, urethanes, polyurethanes, cyanoacrylates, acrylics, and silicones.
